(19) United States
(12) Patent Application Publication
(10) Pub. No.: US 2022/0372988 A1
(43) Pub. Date: Nov. 24, 2022

(54) PUMP FOR A WATER-CARRYING HOUSEHOLD APPLIANCE AND WATER-CARRYING HOUSEHOLD APPLIANCE HAVING SUCH A PUMP

(71) Applicant: E.G.O. Elektro-Geraetebau GmbH, Oberderdingen (DE)

(72) Inventors: Robin Abendschoen, Eppingen (DE); Daniel Fuchs, Linkenheim-Hochstetten (DE); Uwe Koegel, Keurnbach (DE)

(21) Appl. No.: 17/663,854

(22) Filed: May 18, 2022

(30) Foreign Application Priority Data
May 21, 2021 (DE) 10 2021 205 247.9

(51) Int. Cl. F04D 29/18; F04D 13/06; F04D 29/046; F04D 29/58

(52) U.S. Cl. CPC F04D 29/18; F04D 13/06; F04D 29/046; F04D 29/586

(57) ABSTRACT

An impeller pump for a dishwasher has a pump housing comprising a pump upper portion, pump lower portion and pump outer wall in which a pump chamber is arranged. It has a pump inlet into the pump housing and a pump outlet out of the pump housing and a heating device, which forms the pump outer wall, and a pump drive having a drive rotor, a drive stator having a stator winding and a bearing shaft. The bearing shaft is fixedly arranged on the pump housing and the drive rotor is fixedly connected to the drive rotor and they are rotatably arranged on the bearing shaft. The stator winding is arranged on a region of the pump lower portion which adjoins the pump chamber at the other side thereof in an outward radial direction so that between the pump chamber and stator winding only one wall of the pump lower portion extends so that the stator winding is surrounded by the pump chamber in an annular manner. It can thus be effectively cooled by water in the pump chamber.

### CROSS-REFERENCE TO RELATED APPLICATIONS

This application claims priority to German Application No. 10 2021 205 247.9, filed May 21, 2021, the contents of which are hereby incorporated herein in its entirety by reference.

### APPLICATION FIELD AND PRIOR ART

The invention relates to a pump for a water-carrying household appliance and a water-carrying household appliance having such a pump, wherein the pump is an impeller pump.

WO 2014/198427 A1 discloses such an impeller pump for a dishwasher as a water-carrying household appliance. The pump or a pump drive for it are constructed as so-called wet runners and a drive rotor is securely connected to an impeller by means of a shaft. The drive rotor is thus partially surrounded by water from the pump chamber or comes into contact therewith. Furthermore, the drive rotor has ferromagnetic material. A drive stator having a corresponding stator winding extends radially at the outer side around the drive rotor.

### Problem and Solution

An object of the invention is to provide a pump mentioned in the introduction and a water-carrying household appliance which is provided with such a pump by means of which problems of the prior art can be solved and it is in particular possible to provide a practical and easy-to-assemble pump.

This object is achieved with a pump having the features of claim 1 and by a water-carrying household appliance having the features of claim 24. Advantageous and preferred embodiments of the invention are set out in the additional claims and are explained in greater detail below. In this instance, some of the features are described only for the pump or only for the water-carrying household appliance. However, they are nonetheless intended to be applicable both for such a pump and for such a water-carrying household appliance independently and independently of each other. The wording of the claims becomes the content of the description by explicit reference.

The pump is constructed as an impeller pump and has a pump housing and a pump chamber therein. The pump housing is constructed from at least three components, that is to say, a pump upper portion, a pump lower portion and a pump outer wall. The pump chamber itself is formed by the pump upper portion and the pump lower portion and the pump outer wall and is thus partially formed directly by the pump housing. Advantageously, the pump housing has numerous other components or some of the components mentioned, in particular the pump upper portion and pump lower portion, extend functionally and structurally further and provide even more functions than only the ones required for the pump chamber. The pump outer wall is advantageously only the circumferential delimitation for the pump chamber between the pump upper portion and pump lower portion, in particular it may be constructed in a tubular manner. Furthermore, a pump inlet into the pump housing and a pump outlet out of the pump housing may be provided, wherein the pump inlet advantageously extends directly into the pump chamber. The pump outlet advantageously extends out of the pump chamber. As a result of the configuration as an impeller pump, the pump inlet at least into the pump chamber is in an axial direction of the pump. The pump outlet at least out of the pump chamber extends at an angle thereto, advantageously between 60° and 120°, in a particularly advantageous manner almost or completely tangentially or as an externally intersecting secant. The pump has a heating device which is formed on the pump outer wall or which itself forms the pump outer wall. Furthermore, the pump has a pump drive which in conventional manner per se has a drive rotor and a drive stator. There is also provided a bearing shaft which extends along the axial longitudinal axis of the pump. The drive stator has a stator winding so that the drive rotor is not electrically contacted. The entire pump drive is constructed as a wet runner so that the drive rotor so to speak runs in water or is at least partially surrounded by water and is consequently also connected to the pump chamber in a water-carrying manner or is in the pump chamber.

According to the invention, the bearing shaft is arranged on the pump housing in a fixed and non-movable manner, detailed possibilities are explained in greater detail below. The drive rotor is rotatably arranged on the bearing shaft, advantageously by means of suitable bearings. In this instance, the drive rotor may be arranged or extend on a base or slightly above a base of the pump lower portion. The impeller is fixedly connected to the drive rotor and consequently also rotatably supported on the rotary shaft. Furthermore, as a result of the secure connection, it is non-movable with respect to the drive rotor. It can at least partially be constructed or produced together therewith, which will be explained in greater detail below.

Furthermore, the stator winding is arranged on a region of the pump lower portion which adjoins the pump chamber in an outward radial direction, that is to say, at the other side thereof, so that between the pump chamber in this region and the stator winding substantially only one wall of the pump lower portion extends, or only one wall of the pump lower portion extends such as exactly one wall, preferably no other parts of the pump is between the pump chamber and the stator winding in this region. Consequently, the pump chamber is pulled so far down in an axial direction of the pump or the drive stator is displaced so far upwards towards the impeller that the drive stator or the stator winding are also surrounded by the pump chamber in a radial direction. This enables good cooling of the stator winding by the water in the pump chamber. Furthermore, a construction which is compact in an axial direction can thus be achieved. The stator winding is thus surrounded in an annular manner by the pump chamber. In this instance, it should be ensured in all cases that the drive stator is sealed with respect to the pump chamber.

Consequently, as a result of the invention, a pump which enables an advantageous cooling of the drive stator or the stator winding thereof can be provided. A cooling of the drive rotor can advantageously be carried out in that it is also constructed as a wet runner and consequently is well cooled in any case. The compact construction in an axial direction enables a relatively short length of the pump and consequently an advantageous arrangement in the household device without taking up an unnecessarily large amount of space.

In an advantageous embodiment of the invention, the drive stator has a radially outwardly extending stator winding and radially inside it means for magnetic field conduction. These means for magnetic field conduction are advantageously constructed as a stator lamination bundle, as known per se. This structure has the advantage that the magnetic field with respect to the drive rotor which is arranged radially inside and which is surrounded by the drive stator can be configured in the best possible manner or can be configured as desired. Furthermore, the radially outwardly extending stator winding is located as close as possible to the pump chamber which surrounds it and can consequently be cooled in the best possible manner by means of water which is located and circulating therein. It is thus, for example, possible for the drive stator to be placed or mounted in a corresponding protuberance of the pump housing or the pump lower portion. In a downward direction or in the direction away from the pump upper portion, it may be open so that an electrical connection to the stator winding can be carried out in the best and simplest manner possible. The drive stator when viewed in a radial direction is thus preferably located between the drive rotor which is radially inside it, and the pump chamber or a part or portion of the pump chamber which is arranged radially outside it. In particular, the region of the pump chamber which merges completely or at least partially into the pump outlet is located radially outside the drive stator.

Whilst the drive stator has the means mentioned for magnetic field conduction in addition to the stator winding, the drive rotor may have ferromagnetic material or a rotor lamination bundle. Advantageously, the drive rotor has ferromagnetic material which, for example, may be embedded in plastics material or surrounded by plastics material walls. This may be a so-called rotor housing so that this ferromagnetic material or a rotor lamination bundle cannot come into contact with water. Alternatively, a completely produced ferromagnetic material, for example, in annular form or part-annular form, may be injected with plastics material or placed in prefabricated plastics material components, for example, in shell form and adhesively bonded. As another alternative, the ferromagnetic material of the drive rotor may be added to a plastics material or be mixed with a plastics material. The entire drive rotor can thus be produced in a casting method or plastics material injection-moulding method. In this instance, at least a portion of the impeller can potentially also be produced in the same step, in particular a lower covering plate which will be further explained below.

In one possible embodiment of the invention, the pump chamber does not extend in the axial length of the drive stator completely outside it, but instead only partially. However, it should advantageously extend at least along 70% of the axial length thereof, in particular along at least 90%. The best possible cooling of the drive stator or the stator winding thereof can thereby be carried out by the water in the pump chamber. However, the pump chamber does not have to extend completely at the outer side on the drive stator or the stator winding.

In another advantageous embodiment of the invention, an upper side or an upper end face of the drive stator or the stator winding are also in abutment with the pump chamber. In particular, the upper end face of the drive stator is separated from the pump chamber by the wall of the pump lower portion. Consequently, a cooling can also be carried out by the water in the pump chamber here so that the drive stator can even be cooled at two sides.

Advantageously, there is provision for the pump inlet to extend centrally and axially into the pump housing and into the pump chamber. The impeller can then directly adjoin the pump inlet. The pump inlet may be formed at least partially in a tubular manner or in the manner of a pipe socket. In an advantageous development of the invention, the pump inlet may be formed on the pump upper portion itself or be formed thereby. The pump outlet in turn can nonetheless be formed on the pump lower portion and, when viewed in an axial length of the pump, be arranged at least below the impeller. The pump outlet may even be located even further away from the pump inlet along the axial length of the pump, for example, at least partially below the drive stator. However, it does not have to be located completely below the drive stator, whereby an entire axial length of the pump can again be limited.

The pump outer wall is advantageously constructed in a tubular, in particular cylindrical or round-cylindrical manner. The pipe portion may be cut at both ends in a linear and right-angled manner with respect to the axial length thereof. Advantageously, the pump outer wall also extends concentrically with respect to the longitudinal centre axis of the pump and the bearing shaft.

At an outer side of the pump outer wall, heat conductors may be arranged in order to form the heating device. These heating conductors may be constructed as a thin-layer or thick-layer heating device, alternatively also by other heating means such as, for example, tubular heating members. It is thus possible for the heat conductors to be separated from the water in the pump chamber by the pump outer wall. As a result of a pump outer wall which is constructed in a thin manner, for example, from 0.1 mm to 3 mm, a very good heat transfer into the water in the pump chamber is possible. For example, the pump outer wall may be formed from metal, for example, as a metal pipe, and the above-mentioned heat conductors may be pressed on as a thin-layer or thick-layer heating device. In this regard, reference may be made, for example, to WO 2014/198427 A1 and DE 10 2011 003 464 A1 mentioned in the introduction.

In one embodiment of the invention, the bearing shaft is fixedly arranged on the pump lower portion by being pressed or even injected therein. The bearing shaft advantageously comprises metal, alternatively it may also comprise plastics material, for example, a different plastics material from the remaining pump lower portion, preferably stable fibre-reinforced plastics material. Consequently, a corrosion problem can also be reduced.

The drive rotor which can be rotated with respect to the bearing shaft is advantageously supported thereon in the lower region thereof by means of a radial bearing. Another radial bearing may be provided in the upper region of the drive rotor, potentially also on an impeller which is arranged thereabove and which is securely connected thereto. However, this does not necessarily have to be the case, particularly when an axial bearing on the upper end of the impeller in addition also brings about a degree of radial support. In any case, the arrangement of the axial bearing at the top on the impeller has the advantage that it can easily abut an axial counter-bearing. This is supported in the pump inlet, advantageously by means of radially extending webs. The axial counter-bearings and axial bearings are consequently located in the incoming flow of water, but at the same time this may, on the one hand, bring about a cooling and where applicable also a lubrication, and, on the other hand, other locations are substantially even more complex. Furthermore, no special bearing shaft then has to be provided, but instead this can be constructed in a quite simple and linear manner. Consequently, it is possible to limit to a total of two bearings, that is to say, the radial bearing and the axial bearing.

A radial bearing may, on the one hand, be produced from plastics material, on the other hand, from suitable ceramic material or a sintered material. It may be clamped or securely bonded on the drive rotor or, alternatively, it may also be injected. In order to be able to configure it in a simple manner, it should be constructed in such a manner that it does not have to or cannot take up any forces in an axial direction. Potentially, sealed roller bearings, in particular ball bearings or needle bearings, which usually have even less friction may also be provided. However, these should then be well sealed.

The axial bearing advantageously comprises a different material from the impeller on which it is arranged. It may be produced separately and be arranged on the impeller or on the drive rotor. Potentially, it may also be injected in the impeller, for example, in a two-component injection-moulding method.

Generally, the axial bearing may have a convex tip on the impeller. It may be curved in a convex manner in the direction away from the impeller to the pump inlet and when the axial counter-bearing is also curved in a similar manner, a radial centering may be enabled in addition to the axial abutment. Since the axial bearing is arranged at the location of the rotating portion which is arranged furthest away or highest, both for the axial bearing and also for the radial bearing the best possible force relationship for a desired defined bearing of the structural unit comprising the drive rotor and impeller is provided. Alternatively, it is also conceivable to curve the axial bearing on the impeller and the axial counter-bearing in the opposite direction, whereby in addition to an axial abutment a radial bearing as a centring is also possible. An axial bearing, potentially also the axial counter-bearing, may have graphite-containing plastics material or be formed from graphite-containing plastics material. It may be injected into or injected onto both the impeller and the pump upper portion, potentially also subsequently secured, for example, adhesively bonded and/or clamped.

In an alternative embodiment, an axial bearing for the drive rotor may be provided on the radial bearing thereof. Only a single bearing thus needs to be provided, but would have to be configured in a significantly more complex manner.

For the structural unit comprising the drive rotor and impeller, there may be provision for it to have a given movement path in the axial direction of the pump, for example, from 0.1 mm to 10 mm, advantageously from 0.5 mm to 5 mm. When the pump is operated, the impeller as a result of its pump function is generally drawn in an axial direction towards the pump inlet so that, when used and when applied, the above-described axial bearing is sufficient to support it in this instance in an axial direction. As a result, in the idle state of the drive rotor/impeller, even a spacing between the axial bearing and axial counter-bearing may be provided, advantageously in the above-mentioned region, in a particularly advantageous manner between 0.5 mm and 3 mm. It is thus also possible for the two mentioned bearings, that is to say, axial bearing and radial bearing, to be sufficient.

When the drive rotor and the impeller do not rotate, there may be provision for a free end or an end face of the bearing shaft to be in abutment with an end or an inner end face of a receiving opening on the impeller in which the bearing shaft is inserted. It may thus be possible for the drive rotor not to be in abutment at the lower side thereof or never at the upper side of the pump lower portion, but instead for a spacing to be provided therebetween. This spacing may, for example, be between 1 mm and 10 mm. It may thereby be possible for the drive rotor to nonetheless be able to rotate in the dry state of the pump and for a bearing and consequently also friction to be produced only between the end of the bearing shaft and the mentioned inner end face of the impeller. This can be readily absorbed in this instance, for example, by means of a structural configuration or corresponding material selection. In any case, it is thus possible to prevent particularly the lower side of the drive rotor from rubbing or scratching the pump lower portion. A dry running of the pump cannot realistically be prevented, however, potential damage resulting therefrom can at least be prevented in this instance.

In another embodiment of the invention, a structural unit comprising the impeller and drive rotor may at least partially be constructed in one piece in such a manner that advantageously at least a lower portion of the impeller is constructed together with the rotor housing or the entire drive rotor. Such a lower portion of the impeller may not only involve a type of lower impeller covering plate, but also a generally radially internally raised region of the impeller. This radially internally raised region may at its highest point form or have the above-described axial bearing.

In an advantageous embodiment, an upper portion of the impeller can then be formed as an individual separate component, advantageously from plastics material, and be secured to the lower portion of the impeller. A securing should in this instance be non-releasable, adhesive bonding, welding ultrasonic welding or friction welding are possible. This upper portion of the impeller advantageously also has the impeller blades at least partially, advantageously completely. A shape and consequently also a production operation for the lower portion of the impeller together with the drive rotor or rotor housing may thus be configured in a simple manner.

Alternatively, the impeller may be produced separately from the drive rotor, for example, in a single-component or multi-component injection-moulding method. The impeller may advantageously be produced in one piece, alternatively in two pieces with a lower portion and upper portion, wherein the impeller blades are formed on one of the two portions. The impeller which is connected thereto is then connected to the drive rotor to form a structural unit, for example, adhesively bonded or welded in one of the above-mentioned manners.

In a preferred embodiment of the invention, the pump outlet may be provided in a region of the pump or the pump chamber which, when viewed in the longitudinal direction of the pump, is located furthest away from the pump inlet. This may advantageously also be the lowest portion of the pump chamber so that, in the case of a potential vertical arrangement of the pump, water flows away from the pump chamber independently, at least when a drain or the like is not closed by means of a valve or the like. Hygiene problems within the pump or within the pump chamber can thus be reduced.

In another possible advantageous embodiment of the invention, the pump inlet may be constructed, in addition to a possible above-mentioned tubular form, so as to be increasingly expanded upwardly or in a direction away from the impeller or the pump chamber. In this instance, a type of flat wide funnel may be formed. An expansion is advantageously carried out to a diameter which is even greater than the pump chamber. A sump for a dishwasher or a washing machine can thus be formed so that it does not have to be produced as a separate component and then connected to the pump inlet in a water-tight manner.

Preferably, there may be provided on the pump lower portion at least one guide vane which protrudes into the pump chamber. Such a guide vane is advantageously provided on a wall which extends radially externally outside and where applicable along the drive stator, advantageously in an axial direction. In a particularly preferred manner, such a guide vane is produced in one piece and integrally with the pump lower portion. In the circumferential direction of the pumped water, it may have an inclination in a downward direction or towards the pump outlet and may serve to control the water flow within the pump chamber.

In a possible development of the invention, locking apparatuses may be provided on the pump or on the pump housing in order to hold it together. Advantageously, the locking apparatuses are formed in one piece and integrally and all extend in a similar manner either from the pump upper portion to the pump lower portion or vice versa. The locking apparatuses may thus be connected at one end to one of the two portions of the pump housing integrally and in one piece or formed thereon. The other free end is securely locked to the other portion in each case. Separate means can then be dispensed with in order to hold the pump housing together.

In a preferred embodiment of the invention, the pump is installed vertically in a water-carrying household appliance so that the bearing shaft extends vertically. In this instance, there is advantageously provision for the pump inlet to face upwards or to be arranged at the top and consequently to virtually form the highest portion of the pump. The pump outlet then forms, as described above, the lowest point of the pump chamber, for example, for an advantageous independent extensive emptying of the pump chamber. Preferably, the pump is arranged directly below a processing chamber of the water-carrying household appliance, in particular when installed in a dishwasher, so that also in this instance no interposed valves or the like are required.

These features and other features will also be appreciated, besides from the claims, from the description and the drawings, wherein the individual features may be implemented in each case alone or together in the form of sub-combinations in an embodiment of the invention and in other fields and can represent advantageous embodiments which are patentable per se and for which protection is claimed. The sub-division of the application into intermediate headings and individual sections does not limit the statements made thereunder in terms of their general validity.

### BRIEF DESCRIPTION OF THE DRAWINGS

Embodiments of the invention are illustrated in the drawings and are explained in greater detail below. In the drawings:

FIG. 1 shows a schematic view of a dishwasher as a household appliance according to the invention with a pump according to the invention,

FIG. 2 shows a section through the pump according to the invention, and

FIG. 3 is an enlarged section through a modified impeller for a pump according to the invention.

### DETAILED DESCRIPTION OF THE EMBODIMENTS

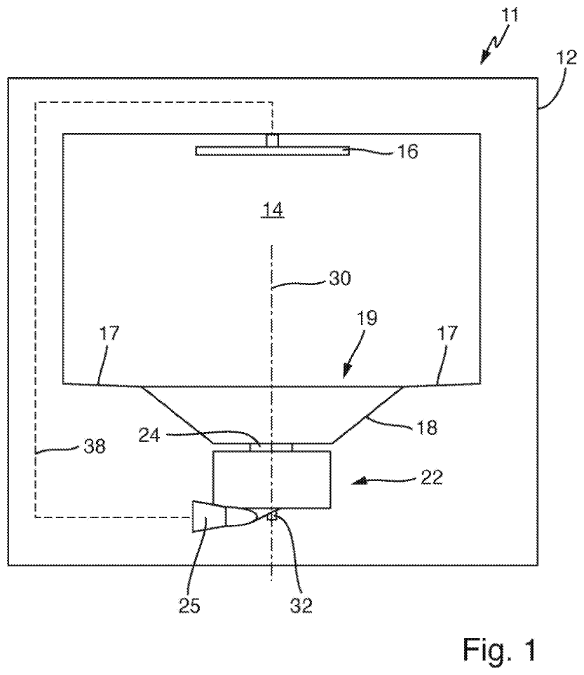

FIG. 1 schematically illustrates a dishwasher 11 as a household appliance according to the invention having a housing 12 and a washing space 14 as a water processing space therein which in principle is constructed in conventional manner and as known. At the top in the washing space 14, a conventional washing arm 16 is indicated, wherein naturally also even more washing arms may be provided therein, in particular also in the lower region. It is supplied by means of a water line 38 which is illustrated with dashed lines. At the bottom, the washing space 14 has a base 17 which merges centrally into a large recess 18, which is constructed in a funnel-like manner and forms a sump 19 having a drain described above. In this instance, the recess 18 may also be partially covered by a grid, for example, as a filter. The walls of the cleaning space 14 and the base 17 generally comprise metal or high-grade steel. The recess 18 in turn may comprise plastics material, alternatively also metal.

At the bottom on the recess 18, a pump 22 according to the invention is arranged as an impeller pump and connected thereto in known manner so as to carry water. A connection of the pump 22 to the recess 18 advantageously has a seal which is not illustrated. A fixing between the two members, recess 18 and pump 22, may be carried out as desired.

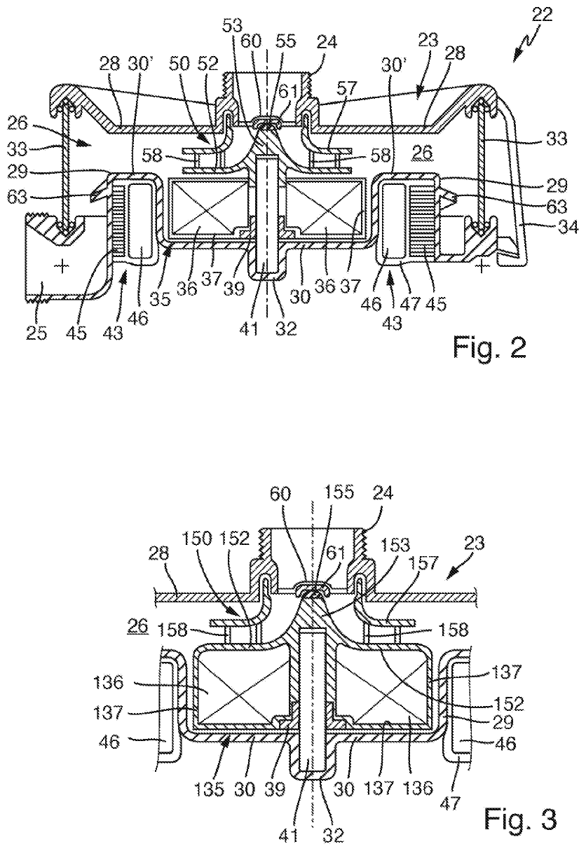

According to FIG. 2, the pump 22 has a pump housing 23 having a pump inlet 24 and a pump outlet 25 of a circumferential pump chamber 26 which can be seen clearly in section. The pump inlet 24 is a short pipe socket along the longitudinal axis, which is illustrated with dot-dash lines, of the pump 22. The pump outlet 25 protrudes laterally and substantially tangentially, it has an angle of approximately 90° with respect to the longitudinal axis of the pump. It may be connected to the above-mentioned water line 38 directly or by means of valves.

FIG. 2 also shows how a pump chamber 26 is formed in the pump housing 23. The pump chamber 26 is formed in an upward direction by a pump upper portion 28, in which the pump inlet 24 is formed centrally, and in a downward direction by a pump lower portion 29, from which the pump outlet 25 extends at the bottom to the left. In an outward direction, the pump chamber 26 is delimited by the pump outer wall 33, which is advantageously constructed as a heating device described above. To this end, it may have a round-cylindrical metal pipe and thereon on the outer side heat conductors, advantageously thick-layer heat conductors. The metal pump outer wall 33 is sealed along the upper edge and along the lower edge by means of suitable seals on the pump upper portion 28 and on the pump lower portion 29 and is retained by them being pressed together. For this pressing together action, there is illustrated on the right a locking arm 34 which is constructed integrally on the pump upper portion 28 and which is engaged by means of a corresponding locking projection on the pump lower portion 29. In a circumferential direction, from two to six such locking arms 34 may be provided in a distributed manner.

The configuration of the pump upper portion 28 can be seen relatively easily in FIG. 2, wherein it particularly also has the locking arms 34 mentioned. The configuration of the pump lower portion 29 is slightly more complex, in this instance there is provided a downwardly pulled central region which forms a receiving recess 30. At the centre along the dot-dash longitudinal axis of the pump 22, a bearing receiving member 32 which also extends further in a downward direction is formed. Radially outside the receiving recess 30, a circumferential receiving protuberance 30′ which extends so to speak in an upward direction is provided. This receiving protuberance 30′ is angled in a radially outward direction through approximately 90° and then extends again substantially parallel with the longitudinal axis of the pump as far as a type of pump chamber base. This pump chamber base then merges into the pump outlet 25, as is also known from the pumps according to the prior art mentioned in the introduction. There is illustrated on the radially outwardly facing wall a guide vane 63 which is formed circumferentially and with a known inclination.

Substantially inside the receiving recess 30, a drive rotor 35 is rotatably supported. The drive rotor 35 has ferromagnetic material 36 which is arranged in an annular manner and which is arranged in a rotor housing 37 and is surrounded thereby. In the lower region or at the lowest region, the drive rotor 35 has a radial bearing 39 which is, for example, pressed in. The radial bearing 39 may advantageously comprise sintered metal or ceramic material.

According to a possibility mentioned in the introduction, the drive rotor 35 may have a separate ring made of ferromagnetic material 36 which is either placed or injected in a rotor housing 37 made of plastics material. The rotor housing 37 may also comprise at least two portions, which surround the ferromagnetic material 36 and which are adhesively bonded or welded to each other. The radial bearing 39 may be pressed in and where applicable also adhesively bonded or welded.

In an alternative embodiment of the invention, the ferromagnetic material 36 may be mixed with plastics material in granular or powdered form and the drive rotor 35 can then in a manner of speaking be cast or injected in an integral manner. In this instance, the radial bearing 39 can also be injected.

A bearing shaft 41 is inserted and secured in the bearing receiving member 32, preferably by means of a press-fit or clamping fit. Alternatively, the bearing shaft 41 may also be injected into the pump lower portion 29 or into the bearing receiving member 32. The bearing shaft 41 may comprise metal or high-grade steel, alternatively it may also comprise a suitable stable plastics material, for example, a fibre-reinforced plastics material. It thus forms a fixed bearing shaft on which the drive rotor 35 is rotatably supported by means of the radial bearing 39.

In the receiving protuberance 30′ which surrounds the receiving recess 30 and consequently also the drive rotor 35 in a radial direction, a circumferential drive stator 43 is arranged. The drive stator 43 has a stator winding 45 which extends or is arranged radially at the outer side and with little spacing therefrom in a radially inner direction a stator lamination bundle 46 is arranged. This serves in known manner to guide the magnetic field in a desired manner. The drive stator 43 may either be constructed as an independent structural unit and then secured in the receiving protuberance 30′, for example, securely bonded or securely locked. Alternatively, as illustrated herein, it may be cast in a durable and stable manner as a structural unit or also stator winding 45, on the one hand, and stator lamination bundle 46, on the other hand, by means of casting resin 47. Electrical connections on the stator winding 45 are not illustrated in this instance but can be readily envisaged and implemented.

Above the drive rotor 35 there is provided an impeller 50 which is constructed in a manner known per se. The impeller 50 has a lower covering plate 52 which centrally has a projection 53 which extends upwards by a significant distance. A bearing tip 55 mentioned in the introduction is arranged on the projection 53 as an axial bearing or as part of an axial bearing. The bearing tip may be constructed and secured in a manner mentioned in the introduction, for example, it may be an adhesively bonded or injected component made of metal or ceramic material.

Above the lower covering plate 52, an upper covering plate 57 extends and impeller blades 58 are indicated therebetween. The impeller 50 may be produced either in a manner known per se from two members, that is to say, substantially from a lower covering plate 52 and an upper covering plate 57. The impeller blades 58 may in this instance be arranged on one of these covering plates or be produced in one piece and integrally therewith. The two members of the impeller are then connected to each other, for example, adhesively bonded or welded. Alternatively, an impeller may also be produced in one piece, as known from DE 102012209832 B3. However, for example, the bearing tip 55 must then be subsequently fitted.

The impeller 50 may be connected to the drive rotor 35 in a different manner. The upper end of the bearing shaft 41 protrudes from below into the impeller 50, but a radial spacing should be provided in this instance so that at least during pump operation or during normal operation the bearing shaft 41 does not abut or rub on the impeller 50 in a radial direction. It can be seen that, between the uppermost end of the bearing shaft 41 and the opposing base face of the impeller 50, a small spacing is provided, for example, a few millimetres. This has been explained in the introduction. This spacing serves to ensure that the structural unit comprising the drive rotor 35 and impeller 50 can be moved in the longitudinal direction of the pump slightly in a downward direction. In this instance, the upper end of the bearing shaft 41 should strike the impeller 50 in an axial direction at the inner side before the lowest region of the drive rotor 35 or the rotor housing 37 thereof moves into abutment with the receiving recess 30. Alternatively, the impeller 50 may also be supported with another radial bearing at the upper end of the bearing shaft 41.

The axial bearing mentioned in the introduction is formed by the bearing tip 55 on the impeller 50. An axial counter-bearing 61 is arranged on a bearing holder 60 which is provided inside the pump inlet 24, at locations where the pump inlet 24 virtually opens in the pump chamber 26. The bearing holder 60 may be retained in a manner known per se by means of two to four radial struts. The axial counter-bearing 61 may be adhesively bonded to the bearing holder 60, alternatively it may be injected on or injected in. It advantageously comprises a suitable bearing material, for example, ceramic material or sintered metal, potentially also a plastics material such as Delrin or the like.

FIG. 2 shows that the drive rotor 35 and consequently a pump drive is constructed as a wet runner. Water can run inside the pump chamber 26 between the drive rotor 35 and pump lower portion 29 in a downward direction as far as the receiving recess 30. In this manner, the drive rotor 35 may be cooled by water. Furthermore, no problems arise with a complex seal.

The drive stator 43, in particular the stator winding 45, as a result of the special arrangement within the receiving protuberance 30′, can also be effectively cooled by means of water which is circulating in the pump chamber 26. A cooling is possible in the upper region of the receiving protuberance 30′ which extends substantially in a radial direction. A relatively direct cooling of the stator winding 45 at the radially outwardly facing side is also possible, at locations where water is present in the region of the guide vanes 63. On the radially inwardly facing side of the receiving protuberance 30′, that is to say, in the direction towards the drive rotor 35, water is also present and can thus also cool the stator lamination bundle 46 or via this the stator winding 45.

Furthermore, it can be seen in FIG. 2 that the pump 22 is relatively short in an axial longitudinal direction as a result of a high level of axial integration.

An alternative embodiment for a pump 22 is illustrated in FIG. 3. A pump housing 23 having an illustrated pump upper portion 28 and pump lower portion 29, in particular with the receiving recess 30, is constructed according to FIG. 2. This also applies to a bearing receiving member 32 together with the bearing shaft 41 which is securely arranged therein. The structural unit comprising the drive rotor 135 and impeller 150 is constructed differently in this instance. In this instance, ferromagnetic material 136 is constructed for the drive rotor 135 in annular form, but not with a rectangular cross section, but instead pulled slightly upwards in a direction towards the centre at the upper side. This ferromagnetic material 36 is overmoulded with a rotor housing 137 which at the same time forms a lower covering plate 152 for the impeller 150. The central raised portion 153 is also formed directly thereon. A radial bearing 139 can in turn be directly injected therein, alternatively subsequently secured by means of clamping or the like.

An upper covering plate 157 of the impeller 150 is produced separately and is connected thereto, for example, adhesively bonded. Impeller blades 158 may in turn be formed on one of the two portions, advantageously this is recommended to be on the upper covering plate 157.

Alternatively, a separate rotor housing 137 could be dispensed with completely and the entire drive rotor, potentially with the exception of an upper covering plate of the impeller and/or the impeller blades, could be produced by means of injection-moulding from a plastics material to which a high proportion of ferromagnetic material is added.

1. Pump for a water-carrying household appliance, wherein said pump is an impeller pump having an impeller and having:
a pump housing, wherein said pump housing is constructed from at least three components, that is to say, a pump upper portion, a pump lower portion and a pump outer wall,
a pump chamber in said pump housing, wherein said pump chamber is formed by said pump upper portion, said pump lower portion and said pump outer wall,
a pump inlet into said pump housing and a pump outlet out of said pump housing,
a heating device, wherein said heating device is formed on said pump outer wall or forms said pump outer wall,
a pump drive having a drive rotor and a drive stator and a bearing shaft, wherein
said drive stator has a stator winding,
said pump drive is a wet runner,
wherein:
said bearing shaft is arranged on said pump housing in a fixed and non-movable manner,
said drive rotor is rotatably arranged on said bearing shaft,
said impeller is fixedly connected to said drive rotor,
said stator winding is arranged on a region of said pump lower portion which adjoins said pump chamber at an other side thereof in an outward radial direction so that between said pump chamber and said stator winding substantially only one wall of said pump lower portion extends,
said stator winding is surrounded by said pump chamber in an annular manner.

2. Pump according to claim 1, wherein said drive stator has a radially outwardly extending stator winding and means which are arranged radially inside said stator winding for magnetic field conduction.

3. Pump according to claim 1, wherein said drive stator is arranged in a radial direction between said drive rotor and said pump chamber, wherein said drive rotor is radially inside said drive stator and said pump chamber is arranged radially outside it.

4. Pump according to claim 1, wherein said pump chamber extends at an outer side along at least 70% of an axial length of said drive stator.

5. Pump according to claim 1, wherein said pump inlet is formed in said pump upper portion, wherein said pump outlet is formed in said pump lower portion and, when viewed in an axial length of said pump, is arranged below said impeller but not completely below said drive stator.

6. Pump according to claim 1, wherein said pump outer wall is a pipe portion, wherein said pipe portion is cut at both ends in a linear and right-angled manner with respect to an axial length thereof, wherein, on an outer side thereof in order to form said heating device, there are arranged heat conductors being constructed as a thin-layer or thick-layer heating device.

7. Pump according to claim 1, wherein said bearing shaft is fixedly arranged on said pump lower portion, such as being injected or pressed therein, wherein said drive rotor is rotatably supported on said bearing shaft in said lower region of said drive rotor by means of a radial bearing and is supported in an axial direction at said upper end of said impeller on said pump upper portion by means of an axial bearing.

8. Pump according to claim 7, wherein said axial bearing for said drive rotor is arranged at a central location at an uppermost region or in a region of said drive rotor being closest to said pump inlet and being arranged in extension of said bearing shaft, wherein an axial counter-bearing for said axial bearing is arranged on said pump housing or on said pump upper portion.

9. Pump according to claim 7, wherein said radial bearing is produced from plastics material, suitable ceramic material or sintered metal and is clamped to said drive rotor, wherein said radial bearing does not take up any forces in an axial direction of said rotor.

10. Pump according to claim 7, wherein said axial bearing comprises a different material and is fitted to said impeller, such as adhesively bonded or injected therein, wherein said axial bearing has a convex tip on said impeller made of plastics material, ceramic material or sintered metal.

11. Pump according to claim 7, wherein said axial bearing has on said pump upper portion and/or on said impeller graphite-containing plastics material or is formed from graphite-containing plastics material.

12. Pump according to claim 8, wherein in a state when said impeller in a longitudinal direction of a longitudinal centre axis is at a maximum distance from said pump inlet, between said axial bearing on said impeller and said axial counter-bearing, a spacing of a maximum of 5 mm is provided.

13. Pump according to claim 12, wherein in said state a free end or an end face of said bearing shaft is in abutment with an end or an inner end face of a receiving opening on said impeller for said bearing shaft.

14. Pump according to claim 13, wherein in said state, said drive rotor at a lower side thereof is not in abutment with said upper side of said pump lower portion, but instead has a spacing between 1 mm and 10 mm.

15. Pump according to claim 1, wherein ferromagnetic material or a rotor lamination bundle of said drive rotor is surrounded by a rotor housing and does not come into contact with water in said pump chamber, wherein said rotor housing is securely connected to said impeller in order to form a structural unit.

16. Pump according to claim 15, wherein said rotor housing is constructed in one piece with at least one portion of said impeller, wherein it forms at least partially a lower portion of said impeller.

17. Pump according to claim 16, wherein said rotor housing together with an internally raised region of said impeller is formed at a highest point of said axial bearing of said impeller according to claim 7.

18. Pump according to claim 16, wherein an upper portion of said impeller is constructed as an individual separate plastics material component and is secured to said lower portion of said impeller in a non-releasable manner by means of adhesive bonding, welding, ultrasonic welding or friction welding.

19. Pump according to claim 1, wherein said impeller is produced in a single component injection-moulding method or in a multi-component injection-moulding method and in one piece, and is connected as a complete component to said drive rotor to form a structural unit.

20. Pump according to claim 1, wherein said ferromagnetic material of said drive rotor is added to a plastics material and said entire drive rotor is produced with a plastics material injection-moulding method, wherein at least a portion of said impeller is also produced in the same step.

21. Pump according to claim 1, wherein said pump outlet is provided on a region being located furthest away from said pump inlet when viewed in a longitudinal direction of said pump.

22. Pump according to claim 1, wherein said pump inlet is constructed to be increasingly expanded in a direction away from said impeller to a diameter greater than said pump chamber in order to form a sump for a dishwasher or a washing machine.

23. Pump according to claim 1, wherein it is constructed to be installed vertically or to be installed with a vertically extending bearing shaft.

24. Water-carrying household appliance having a pump according to claim 1, wherein said pump is installed with a vertical bearing shaft, wherein said pump inlet faces upwards or is arranged at a top of said pump.

25. Water-carrying household appliance having a pump according to claim 24, wherein said pump outlet forms a lowest point of said pump chamber.
